(19) United States
(12) Patent Application Publication
(10) Pub. No.: US 2005/0193616 A1
(43) Pub. Date: Sep. 8, 2005

(54) Fishing rod strike sensor

(76) Inventor: Bryan L. Johnson, Clear Lake, MN (US)

Correspondence Address: Richard C. Litman;LITMAN LAW OFFICES, LTD., P.O. Box 15035, Arlington, VA, 22215, US

(21) Appl. No.: 10/790,743

(22) Filed: Mar. 3, 2004

(51) Int. Cl. A01K 97/12

(52) U.S. Cl. 43/17

(57) ABSTRACT

The fishing rod strike sensor provides an audible and visual indication of a fish striking a hook or lure suspended from a fishing rod by a fishing line. A flexible sensor, such as a flexible resistor, extends along the fishing rod, flexing along with the fishing rod. As the sensor flexes, an electrical characteristic of the sensor, such as its resistance, changes according to the degree of flex. An electronic circuit activates an alarm when the electrical characteristic varies beyond a threshold. The electrical circuit is adjustable to set the alarm threshold. A “window” threshold is employed whereby an alarm can be sounded both when a fish pulls on the line when taking the hook, and when a fish takes the hook in a manner that decreases the pull on the line.

### BACKGROUND OF THE INVENTION

1. Field of the Invention

The present invention relates to fishing apparatus, and more particularly to a fishing rod strike sensor for sensing a fish strike by measuring the flexing of a fishing rod.

2. Description of the Related Art

Strike signaling devices for fishing are known and are useful in alerting a fisherman to a fish biting on an untended fishing rod. Such devices are particularly useful where a fisherman is fishing with multiple fishing rods and can attend to only one at a time, or where the fisherman simply wishes to leave a rod unattended rather than holding onto the rod while waiting for a fish to strike.

Various strike signaling devices incorporate an arrangement of electrical contacts, or a switch, that is affixed to a fishing rod and configured to make or break an electrical connection when the fishing rod flexes. A light, or audible alarm, or other signaling device, is activated as the electrical connection opens and closes. These simple switched devices, however, typically lack the ability for adjustments to be made in their sensitivity, or such a sensitivity adjustment is dependent on the positioning of one or more components when the device is installed on the fishing rod. An additional limitation is that, because typical fish strike alarms are activated by a pull on the fishing line, they cannot indicate a strike where a fish takes the hook and carries it toward, rather than away from, the fishing rod, thereby decreasing and not increasing the pull on the fishing line. Several species of fish are known to, on occasion, take a hook in a manner that initially decreases rather than increases the pull on the fishing line. Such a strike is either detected late, or missed entirely, by strike detectors that are activated only by a pull on the line.

U.S. Patent Publication No. 2002/0056221, published on May 16, 2002, discloses a signaling device for alerting fishermen to the presence of fish at the hook including a signal light and sound switching system formed to a fishing rod so that the pull of a fish on the line activates the light and sound.

U.S. Pat. No. 2,302,337, issued on Nov. 17, 1942 to S. Mantell, discloses a signal attachment for fishing poles that consists, basically, of a “pencil” type flashlight having a light bulb at one end and a pushbutton switch at the other, and a spring activating mechanism. The flashlight and activating mechanism are mounted to a fishing rod such that, when the rod bends, the activating mechanism depresses the pushbutton switch to light the light bulb. The device may be adjusted, to require a greater or lesser pull to activate the light, by varying the position of the flashlight relative to the activating mechanism.

U.S. Pat. No. 3,624,689, issued on Nov. 30, 1971 to F. Rizzo, discloses a fishing rod that incorporates a strike-signaling means. A switch assembly and signal light are contained in a line guide at the tip of the rod, and batteries to power the signal light are contained in the handle of the fishing rod. Electrical wires are run within the rod itself to connect the batteries to the switch assembly and signal light at the tip.

U.S. Pat. No. 3,696,546, issued on Oct. 10, 1972 to H. Ambrose, discloses a fish strike alarm device that incorporates electrical contacts that are configured on a fishing rod to make and break electrical connection as the fishing rod flexes. Again, the alarm device may be adjusted to require a greater or lesser pull to activate an alarm circuit by varying the position of contact components along the length of the fishing rod.

U.S. Pat. No. 4,693,125, issued on Sep. 15, 1987 to G. Krutz et al., discloses a force detecting and indicating apparatus for fishing rods. The apparatus includes a microprocessor that responds to a magnetic, Hall effect sensor to detect deflection of a fishing rod caused by a pull on a fishing line attached to the rod. While this device is quite versatile and capable of displaying a large volume of information, it is characterized by a disadvantageously high cost, and a high power requirement leading to shorter battery life, due to the programmed microprocessor, display, keypad, and other components. Additionally, along with the versatility of the device and the volume of information that may be reported by the device comes an added complexity in using the device. An inexpensive and simple to use device is desirable for the simple function of a fishing rod strike alarm.

U.S. Pat. No. 5,259,252, issued on Nov. 9, 1993 to J. Kruse et al., discloses an apparatus for measuring forces on a fishing rod. The apparatus employs one of several types of transducer, contained within a fishing rod, responsive to deflection of the fishing rod. In one embodiment, the transducer is a strain gauge that produces an output in the form of a change in resistance, an electrical signal, or another form. The apparatus, however, provides only for display of the force applied to the fishing rod and not for an alarm to indicate a fish strike. Additionally, because the transducer is contained within the fishing rod itself, it is not suitable for retrofit to existing rods or rods sold without the apparatus.

U.S. Pat. No. 6,393,753, issued on May 28, 2002 to G. Walker, discloses a fishing rod for alerting when a fish has been hooked. The fishing rod employs a switch/transducer that closes when the fishing rod flexes, and that has an output directly proportional to the amount of flexing of the fishing rod. An audio element has an intensity that varies with the amount of flexing of the fishing rod. A light is included, the light being activated when the switch is closed. No provision is made, however, to vary the sensitivity of the alarm.

None of the above inventions and patents, taken either singly or in combination, is seen to describe the instant invention as claimed. Thus a fishing rod strike sensor solving the aforementioned problems is desired.

### SUMMARY OF THE INVENTION

The fishing rod strike sensor of the present invention provides an audible and visual indication of a fish striking a hook or lure suspended from a fishing rod by a fishing line. A flexible sensor, such as a flexible resistor, extends from a housing that attaches to a fishing rod, adjacent to the fishing rod's handle. The sensor extends forward, and is connected to the fishing rod such that, when the rod flexes, the sensor flexes along with the rod. As the sensor flexes, an electrical characteristic of the sensor, such as its resistance, changes according to the degree of flex. Thus, when a fish takes a hook on a fishing line supported by the fishing rod, and in the process changes the degree of flex of the fishing rod, the change in flex can be detected.

An electrical circuit, contained within the housing and electrically connected to the sensor, reacts to the changing electrical characteristic of the sensor and activates an alarm when the electrical characteristic reaches a threshold level. A sensitivity adjustment circuit allows the threshold level to be varied, allowing the alarm to be set for activation at varying degrees of flexing of the fishing rod. In addition to a variable alarm threshold, the electrical circuit may provide a “window” whereby an alarm is activated either if the flexing on the fishing rod is increased or decreased. Thus, an alarm can be sounded both if a fish pulls on the line when taking the hook, and if a fish takes the hook in a manner that decreases the pull on the line.

The housing and sensor may be attached to a fishing rod, either during the manufacture of a new fishing rod, or as an add-on accessory to an existing fishing rod, by clamping the housing to the fishing rod and clipping the forward end of the sensor to the fishing rod. Alternatively, the sensor may be manufactured into the fishing rod, with the electrical circuit contained within a housing or within the handle of the fishing rod.

Accordingly, it is a principal object of the invention to provide a fishing rod strike sensor.

It is another object of the invention to provide a fishing rod strike sensor that activates an alarm when the fishing rod flexes.

It is yet another object of the invention to provide a fishing rod strike sensor that activates an alarm when the fishing rod flexes beyond an adjustable threshold.

It is a further object of the invention to provide a fishing rod strike sensor that activates an alarm when the fishing rod flexes outside of an adjustable window.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, side view of a fishing rod strike sensor according to the present invention mounted on a fishing rod.

FIG. 2 is an exploded side view of a fishing rod strike sensor according to the present invention.

FIG. 3 is an end view of a fishing rod strike sensor according to the present invention.

FIG. 4 is an end view of a flexible resistor and flexible bridge for mounting the flexible resistor to a fishing rod.

FIG. 5 is a side view of a fishing rod strike sensor according to the present invention contained within the handle of a fishing rod.

FIG. 6 is a side view of an alternative embodiment of a fishing rod strike sensor according to the present invention contained within the handle of a fishing rod.

FIG. 7 is a schematic diagram of a comparator and alarm circuit for a fishing rod strike sensor according to the present invention.

FIG. 8 is a schematic diagram of a window comparator and alarm circuit for a fishing rod strike sensor according to the present invention.

FIG. 9 is a schematic diagram of an alternative embodiment for a comparator and alarm circuit for a fishing rod strike sensor according to the present invention.

FIG. 10 is an exploded side view of an alternative embodiment of a fishing rod strike sensor according to the present invention.

Similar reference characters denote corresponding features consistently throughout the attached drawings.

### DETAILED DESCRIPTION OF THE PREFERRED EMBODIMENTS

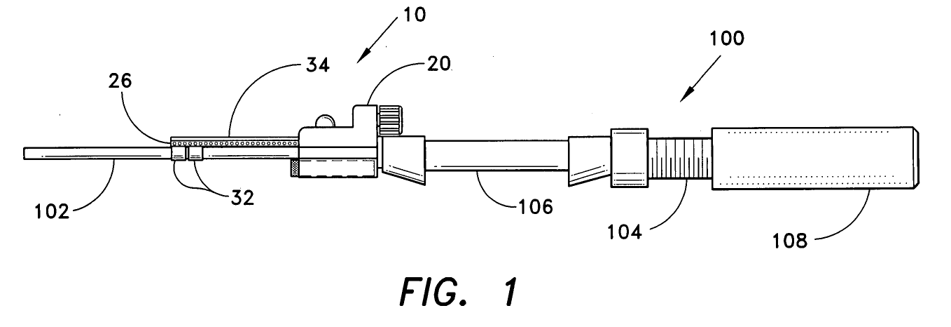

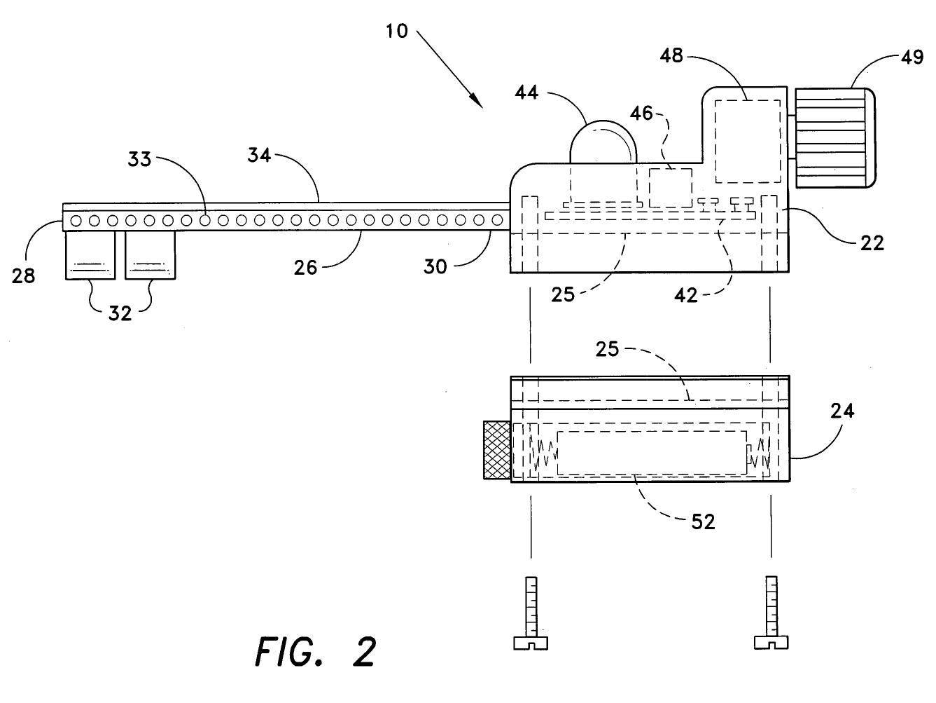

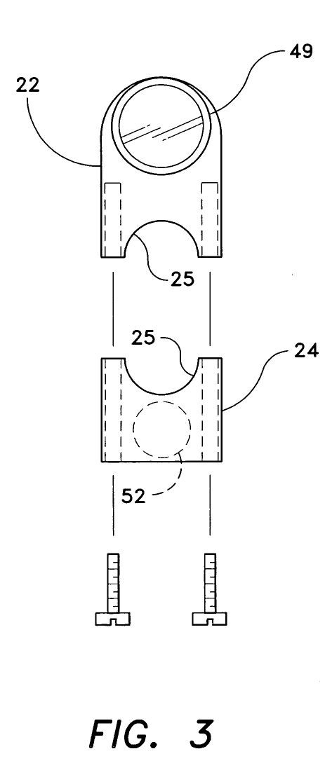

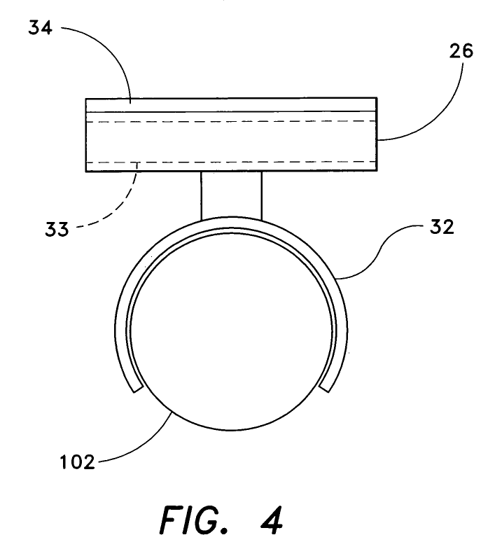

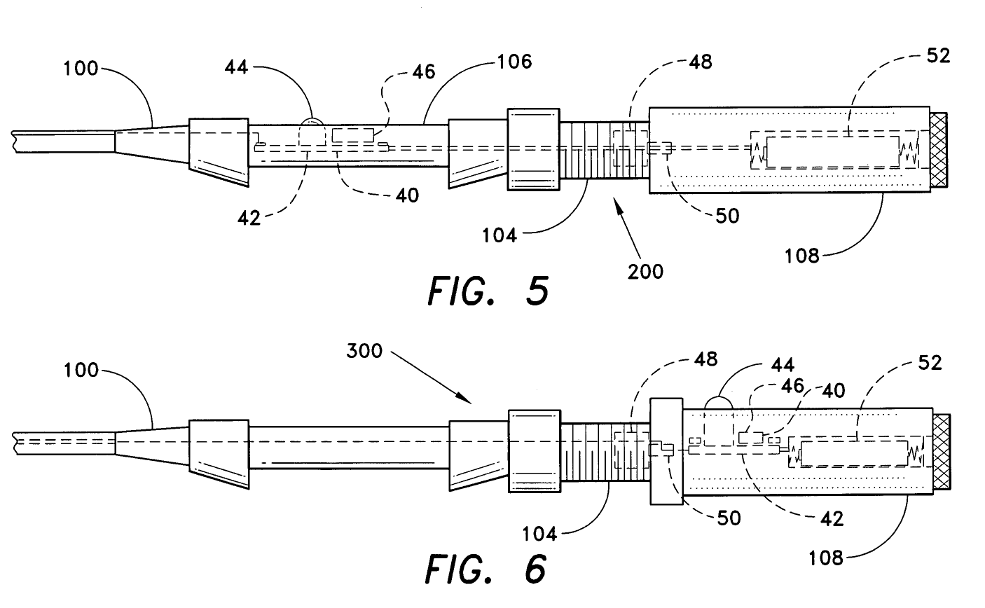

The present invention is a fishing rod strike sensor for alerting an angler, by an audible or visual alarm, to the presence of a fish taking a hook suspended by a length of fishing line from a fishing rod. In a first embodiment, illustrated in FIGS. 1-4, a fishing rod strike sensor 10 can be readily attached to a fishing rod 100. In additional embodiments, shown in FIGS. 5 and 6, the fishing rod strike sensor is fully contained within the fishing rod 100.

Turning now to FIGS. 1-4, fishing rod strike sensor 10 removably mounts onto a fishing rod 100. A typical fishing rod 100 has a rod 102 that extends forward from a handle structure 104, the handle structure 104 including a hand grip 108 and a reel seat 106.

The fishing rod strike sensor 10 employs a flexible sensor 34 to sense flexing of the rod 102. The flexible sensor 34 of the present embodiment is a flexible resistor. Flexible resistors, generally speaking, are an elongated and flat, flexible component whose resistance varies as the component bends or flexes. The “Flex Sensor” line of flexible resistors, manufactured by the Spectra Symbol Company of Salt Lake City, Utah, are exemplary.

To make the fishing rod strike sensor 10 readily attachable to, and removable from, a fishing rod, the flexible sensor 34 is mounted onto a bridge 26 that extends from a housing 20, and clips to the rod 102.

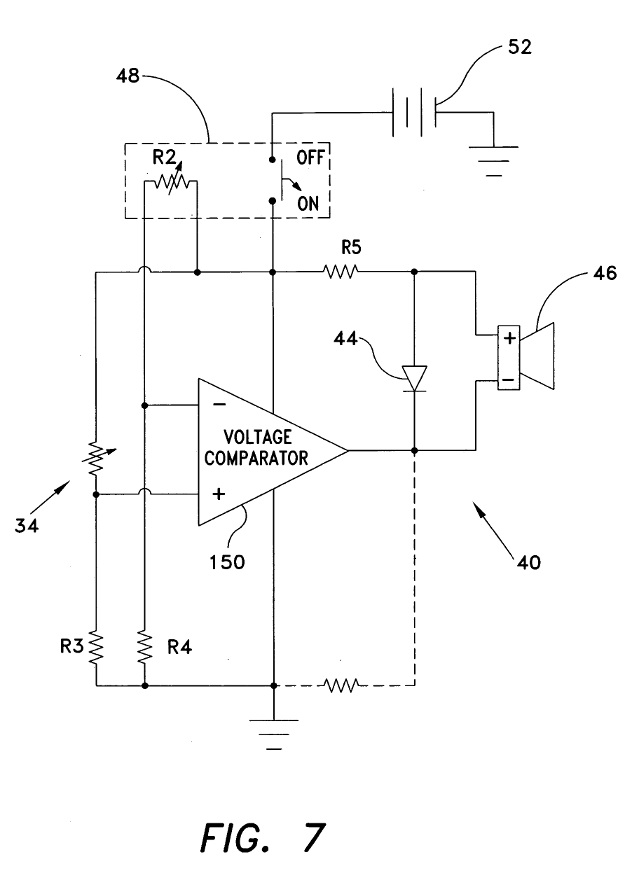

The housing 20 contains an electrical circuit 40 (described in FIG. 7) that measures the resistance of the flexible sensor 34 to activate an alarm when the resistance exceeds a threshold. Housing 20 is in two halves to facilitate attachment to the rod 102. An upper half 22 of the housing contains the electrical circuit 40 on a circuit board 42. Also disposed on the circuit board are a signal light 44, and an audio alarm 46, and a potentiometer or variable resistor 48 for adjusting the circuit's alarm threshold levels. An adjustment knob 49 extends from the housing 20 for adjusting the potentiometer 48. The electrical circuit is discussed in greater detail below.

A lower half 24 of the housing 20 contains a battery 52 to power the fishing rod strike sensor 10. A semicircular channel 25 is formed in both the upper half 22 and the lower half 24 of the housing 20 so that the housing halves may be clamped around the rod portion 102 of a fishing rod 100.

Bridge 26 is an elongated and relatively flat block of a material that is generally rigid, but will flex slightly along with the rod 102. Holes 33 may be formed transversely through the bridge 26 to improve or adjust the flexing characteristic of the bridge 26. A rear end 30 of the bridge 26 is supported by the housing 20, in near proximity to the rod 102 when the housing 20 is attached to the rod 102. A front end 28 of the bridge 26 has at least one clip 32 to attach the bridge 26 to the rod 102. Thus, the fishing rod strike sensor 10 is mounted on a fishing rod 100 by clamping the housing 20 to the rod portion 102, and clipping the forward end 28 of the bridge 26 to the rod portion 102.

In alternative embodiments illustrated in FIGS. 5 and 6, the electronic circuit 40, signal light 44, audible alarm 46, adjusting potentiometer 48, and battery 52 are fully contained within a fishing rod 100.

In a fishing rod strike sensor 200, illustrated in FIG. 5, the flexible sensor 34 is disposed directly on rod 102, affixed in place by an adhesive or other suitable means. The electrical circuit 40, disposed on circuit board 42 along with signal light 44 and audible alarm 46, is contained within the reel seat 106 of fishing rod 100. Battery 52 is contained within a hollow interior of the hand grip 108. Hand grip 108 is rotatably attached to the handle 104. The potentiometer 48 is mounted within the handle 104, with the potentiometer shaft 50 in connection with hand grip 108, so that the potentiometer 48 is adjustable by rotating the hand grip 108.

In a fishing rod strike sensor 300, illustrated in FIG. 6, the flexible sensor 34 is disposed within rod 102. The electrical circuit 40, disposed on circuit board 42 along with signal light 44 and audible alarm 46, is contained within the hand grip 108 of fishing rod 100. Battery 52 is contained within a hollow interior of the hand grip 108. Hand grip 108 is rotatably attached to the handle 104. The potentiometer 48 is mounted within the handle 104, with the potentiometer shaft 50 in connection with hand grip 108, so that the potentiometer 48 is adjustable by rotating the hand grip 108.

Turning now to FIG. 7, an embodiment of the electrical circuit 40 is illustrated in greater detail. The electrical circuit 40 employs a voltage comparator 150 to compare the resistance of the flexible sensor 34 to a threshold that is set by potentiometer 48. The flexible sensor 34, along with resistor R3, form a voltage divider that produces a sensor voltage that varies inversely with the resistance of the flexible sensor 34, the voltage dropping as the resistance of the flexible sensor 34 increases. Similarly, potentiometer 48 (R2), along with resistor R4, form a voltage divider that produces a threshold voltage that can be set and adjusted by potentiometer 48 (R2). A voltage comparator 150 compares the sensor voltage with the threshold voltage and activates the signal light 44 and audible alarm 46 when resistance of the flexible sensor 34 exceeds a threshold level. Thus, the simple comparator circuit 40 allows an angler to adjust the amount of flex required for an alarm to be activated, allowing a threshold to be varied to suit differing fishing conditions. Resistor R9 can be added to provide hysteresis, if desired.

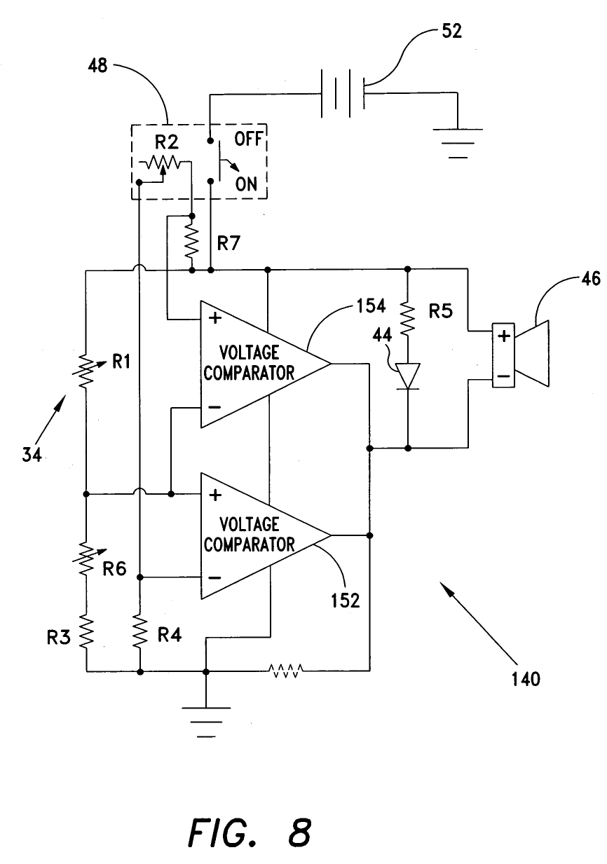

Turning now to FIG. 8, another embodiment of an electrical circuit 140 is illustrated in greater detail. While the electrical circuit 40 shown in FIG. 7 incorporates a single voltage comparator 150 to provide a single variable threshold for activating an alarm, the electrical circuit 140 forms a window comparator capable of activating an alarm if the resistance of the flexible sensor 34 varies in either direction outside of a window defined by upper and lower thresholds.

The electrical circuit 140 employs an upper voltage comparator 152 and a lower voltage comparator 154 to form a window comparator. The flexible sensor 34, along with resistors R3 and R6, form a voltage divider that produces a sensor voltage that varies inversely with the resistance of the flexible sensor 34, the voltage dropping as the resistance of the flexible sensor 34 increases. The sensor voltage is applied to both the upper comparator 152 and the lower comparator 154. Potentiometer 48 (R2), along with resistors R4 and R7, forms a voltage divider that produces an upper threshold voltage, applied to the upper comparator 152, and a lower voltage threshold, applied to lower comparator 154, setting upper and lower window boundaries. Adjusting R2 varies the width of the window defined by the upper and lower window boundaries. Adjusting the value of R6 varies a bias to the sensor voltage, effectively moving the window up or down. Utilizing a dual potentiometer for R2 and R6, with a self-contained on/off switch, provides a convenient adjustment mechanism. Resistor R9 can be added to provide hysteresis, if desired.

The window comparator function provided by the electrical circuit 140 allows an angler to be notified of a fish strike both if a fish pulls on the line when taking the hook, thereby flexing the fishing rod and increasing the resistance of the flexible sensor 34, and if a fish takes the hook in a manner that decreases the pull on the line, thereby deflexing the fishing rod and decreasing the resistance of the flexible sensor 34.

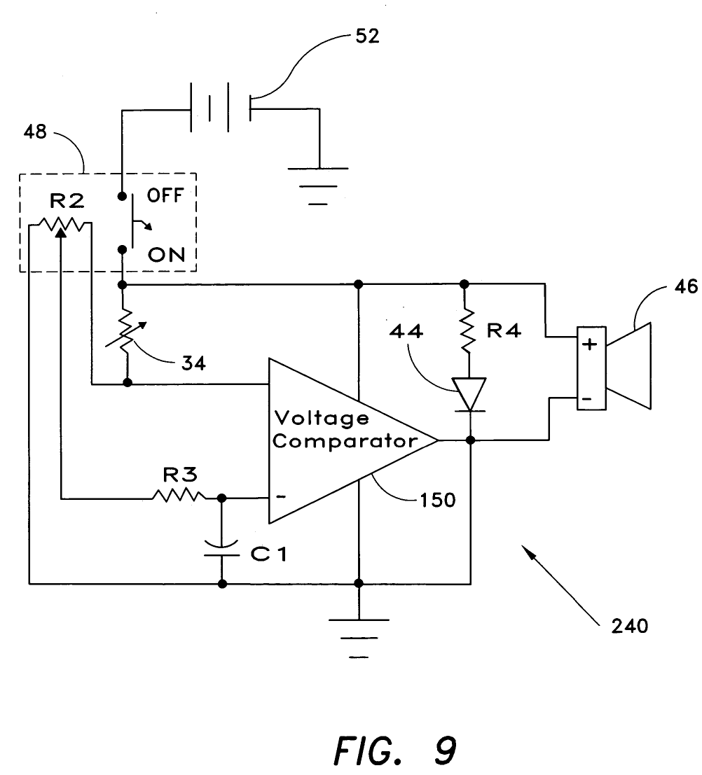

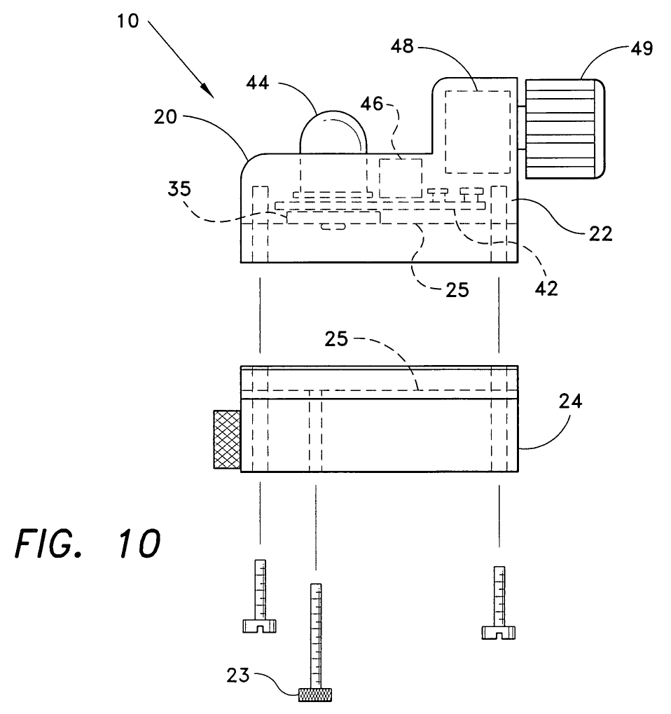

Turning now to FIG. 9, another embodiment of an electrical circuit 240 is illustrated in greater detail. The electrical circuit 240 provides a single threshold which tracks the flexible sensor 34 so that the threshold level of the fishing rod strike sensor 10 does not require resetting to accommodate changes in temperature, changes in the weight or type of fishing lure being used, or changes in the rod flex caused by the stress of catching fish. The flex resistor 34 in series with potentiometer R2 set the threshold level for the comparator 150. The threshold voltage is filtered by R3 and C1, thereby factoring out the effects of slow rate changes, or different steady state baselines, in the resistance of flex resistor 34.

FIG. 10 illustrates both an alternate sensor, and an alternate means of adjusting the sensitivity of the fishing rod strike sensor 10. A force sensor 35 that can be fully contained within the housing 20 replaces the flexible sensor 34. Force sensors are known that provide a resistance that varies with a force applied to the device. Sensor devices IESF-R-5 and IESP-12, manufactured by C U I Inc. of Beaverton, Or., are exemplary. Force sensor 35 is contained within the housing 20, positioned to be in contact with a fishing rod when the fishing rod strike sensor 10 is mounted to a fishing rod. Electrically, the force sensor 35 replaces the flexible resistor 34 in the electrical circuit.

The alternate means of adjusting the sensitivity of the fishing rod strike sensor 10 comprises adjusting screw 23. The adjusting screw 23 is disposed in the bottom half 24 of the housing 20, and may be turned or out against the fishing rod when the fishing rod strike sensor 10 is installed on a fishing rod. The adjusting screw 23 applies a variable force or flex to the fishing rod, and allows a user of the fishing rod strike sensor 10 to make an adjustment in compensation of differently weighted fishing lures or baits, as well as different characteristics of the fishing rod.

It is to be understood that the present invention is not limited to the embodiments described above, but encompasses any and all embodiments within the scope of the following claims.

1. A fishing rod strike sensor, comprising:
a sensor having an electrical characteristic that varies as the sensor flexes;
means for attaching said sensor to a fishing rod such that said electrical characteristic varies as the fishing rod flexes;
an alarm signaling device;
an electrical circuit in electrical connection with said sensor, the circuit defining a first threshold, the circuit having an output that is activated when said electrical characteristic exceeds said first threshold, the output being in electrical connection with said alarm signaling device;
means for adjusting said first threshold; and
an electrical power source in electrical connection with said electrical circuit.

2. The fishing rod strike sensor according to claim 1, further comprising:
a second threshold defined by said circuit, said output being activated when said electrical characteristic falls outside of said first and second thresholds; and
means for adjusting said second threshold.

3. The fishing rod strike sensor according to claim 2, wherein said electrical circuit comprises a window comparator.

4. The fishing rod strike sensor according to claim 1, wherein said sensor is a flexible resistor having a resistance that varies as the flexible resistor flexes.

5. The fishing rod strike sensor according to claim 1, further comprising a housing, the alarm signaling device, electrical circuit, threshold adjusting means, and electrical power source being contained within said housing.

6. The fishing rod strike sensor according to claim 5, wherein said sensor attaching means comprises a bridge having forward and rearward ends, the rearward end supported by said housing and the forward end extending from said housing.

7. The fishing rod strike sensor according to claim 6, further comprising at least one clip disposed on the forward end of said bridge.

8. The fishing rod strike sensor according to claim 1, further comprising a fishing rod having a handle portion and a rod portion, wherein:
the alarm signaling device, electrical circuit, threshold adjusting means, and electrical power source are contained within said handle portion; and
said sensor attaching means comprises means for attaching said sensor to said rod portion.

9. The fishing rod strike sensor according to claim 1, wherein said alarm signaling device comprises a visual signaling device.

10. The fishing rod strike sensor according to claim 1, wherein said alarm signaling device comprises an audio signaling device.

11. A fishing rod strike sensor, comprising:
a sensor having an electrical characteristic that varies as a mechanical force is applied to the sensor;
means for attaching said sensor to a fishing rod such that said electrical characteristic varies as the fishing rod flexes;
an alarm signaling device;
an electrical circuit in electrical connection with said sensor, the circuit defining a first threshold, the output being in electrical connection with said alarm signaling device;
means for adjusting said first threshold; and
an electrical power source in electrical connection with said electrical circuit.

12. The fishing rod strike sensor according to claim 11, further comprising:
a second threshold defined by said circuit, said output being activated when said electrical characteristic falls outside of said first and second thresholds; and
means for adjusting said second threshold.

13. The fishing rod strike sensor according to claim 12, wherein said electrical circuit comprises a window comparator.

14. The fishing rod strike sensor according to claim 11, wherein said sensor is a force sensor having a resistance that varies as a mechanical force is applied to the sensor.

15. The fishing rod strike sensor according to claim 11, further comprising a housing, the sensor, alarm signaling device, electrical circuit, threshold adjusting means, and electrical power source being contained within said housing.
